(19) United States
(12) Patent Application Publication
(10) Pub. No.: US 2025/0196032 A1
(43) Pub. Date: Jun. 19, 2025

(54) FILTER HEAD AND FILTER FOR WATER DISPENSER

(71) Applicant: EMC Water LLC, Downers Grove, IL (US)

(72) Inventors: Bryan Miller, Stockton, IL (US); Glen Trickle, Downers Grove, IL (US)

(21) Appl. No.: 18/980,264

(22) Filed: Dec. 13, 2024

Related U.S. Application Data
(60) Provisional application No. 63/609,725, filed on Dec. 13, 2023.

(51) Int. Cl. B01D 35/30; B01D 35/143

(52) U.S. Cl. CPC B01D 35/306; B01D 35/1435; B01D 2201/167; B01D 2201/303; B01D 2201/4061; B01D 2201/56

(57) ABSTRACT

A filter interface includes a first inlet positioned on a filter head, a second inlet positioned on a filter cap of a filter cartridge, two ledges positioned on the filter head, and at two tabs positioned on the filter cap. The second inlet is selectively coupled to the first inlet to provide fluid communication between the first inlet and the second inlet while the filter cap is secured relative to the filter head. Each of the tabs protrudes in a radial direction. The filter cap and filter head are coupled by translating the filter cap along an insertion direction and rotating the filter cap about the insertion direction toward a locked position, thereby causing each of the tabs to engage one of the ledges and secure the filter cap relative to the filter head. The tabs are positioned asymmetrically as viewed along the insertion direction.

### CROSS-REFERENCE TO RELATED APPLICATION

This application claims the benefit of U.S. Provisional Patent Application No. 63/609,725 filed Dec. 13, 2023, the entire contents of which is incorporated by reference herein.

### TECHNICAL FIELD

The present disclosure generally relates to water filters, and in particular to a filter head and filter to be installed with a water dispenser.

### BACKGROUND

Water filters typically are configured to physically remove solid matter or suspended impurities from a stream of water before water is dispensed for drinking.

### SUMMARY

In one independent aspect, a filter interface is provided for coupling a filter cartridge to a filter head for a water dispensing fixture. The filter interface includes a first inlet positioned on the filter head, a second inlet positioned on a filter cap of the filter cartridge, at least two ledges positioned on one of the filter head and the filter cap, and at least two tabs positioned on the other of the filter head and the filter cap. The second inlet is selectively coupled to the first inlet to provide fluid communication between the first inlet and the second inlet while the filter cap is secured relative to the filter head. Each of the tabs protrudes in a radial direction. The filter cap and filter head are coupled by translating the filter cap along an insertion direction and rotating the filter cap about the insertion direction toward a locked position, thereby causing each of the tabs to engage one of the ledges and secure the filter cap relative to the filter head. The tabs are positioned asymmetrically as viewed along the insertion direction.

In some aspects, the tabs are positioned on the filter cap and the ledges are positioned on the filter head.

In some aspects, each of the tabs includes a tab leading edge for sliding along one of the ledges as the filter cap is rotated about the insertion direction and a tab trailing edge on an opposite end of each of the tabs. One of the tab leading edge and the tab trailing edge protrudes substantially tangentially from an outer periphery of the filter cap.

In some aspects, each of the tabs includes a tab leading edge for sliding along one of the ledges as the filter cap is rotated about the insertion direction and a tab trailing edge on an opposite end of each of the tabs, the tab leading edge protruding a first distance from an outer periphery of the filter cap, the tab trailing edge protruding a second distance from the outer periphery of the filter cap that is different from the first distance.

In some aspects, the at least two tabs are a first tab and second opposing tab. The first tab includes a tab leading edge for sliding along one of the ledges as the filter cap is rotated about the insertion direction and a tab trailing edge on an opposite end of the first tab. At least one of the tab leading edge and the tab trailing edge protrude in a direction that is skewed away from the second opposing tab.

In some aspects, each of the ledges includes a leading edge having a stop protruding parallel to the insertion direction, the stop abutting one of the tabs of the filter cartridge to prevent a misaligned rotation of the filter cartridge relative to the filter head.

In some aspects, the filter interface further includes a first outlet positioned on the filter head, and a second outlet positioned on the filter cap, the second outlet selectively coupled to the first outlet to provide fluid communication between the first outlet and the second outlet while the filter cap is secured relative to the filter head.

In some aspects, the second outlet protrudes from an end surface of the filter cap in a direction parallel to the insertion direction, and the second inlet protrudes from the end surface of the filter cap in a direction parallel to the insertion direction and offset from the second outlet, the second outlet protruding from the end surface by a first distance, the second inlet protruding from the end surface a second distance that is less than the first distance.

In some aspects, the first distance is approximately 40% greater than the second distance.

In some aspects, the filter interface further includes a valve plate supported for rotation relative to the filter head, the valve plate including a first passage and a second passage, the first passage of the valve plate configured to receive the second inlet and the second passage of the valve plate is configured to receive the second outlet. While the filter cap is secured relative to the filter head, the first passage of the valve plate provides fluid communication between the first inlet and the second inlet, and the second passage of the valve plate provides fluid communication between the first outlet and the second outlet.

In some aspects, the filter interface further includes a rib protruding from an outer surface of the first passage, the rib configured to interfere with the filter cap and prevent coupling the filter head and the filter cap when the filter cap is misaligned with the first passage.

In some aspects, the filter interface further includes a retaining plate secured to the filter head. The valve plate is positioned between the retaining plate and a main body of the filter head. The retaining plate includes a cutout, the second inlet and the second outlet extending through the cutout while the second inlet is positioned in the first passage and the second outlet is positioned in the second passage of the valve plate. The retaining plate includes a rib protruding parallel to the insertion direction, the rib engaging an end surface of the filter cap while the filter cap is secured relative to the filter head.

In another independent aspect, a filter cap is provided for fluidly coupling a filter cartridge to a filter head for a water dispensing feature. The filter cap includes a main body having a round profile defining a central axis, an inlet configured to provide a first fluid passageway between the filter cartridge and the filter head, an outlet configured to provide a second fluid passageway between the filter cartridge and the filter head, a first tab protruding radially from an outer periphery of the main body, and a second tab protruding radially from the outer periphery of the main body. The second fluid passageway is distinct from the first fluid passageway. The second tab protrudes asymmetrically relative to the first tab. The first tab and second tab are each configured to selectively engage one of a first and second ledge of the filter head as the filter cap is rotated about the central axis to selectively secure the filter cap to the filter head.

In some aspects, the first tab includes a tab leading edge and a tab trailing edge on opposing ends of the first tab. One of the tab leading edge and the tab trailing edge protrudes substantially tangentially from an outer periphery of the main body.

In some aspects, the first tab includes a tab leading edge and a tab trailing edge on opposing ends of the first tab, the tab leading edge protruding a first distance from an outer periphery of the main body, the tab trailing edge protruding a second distance from the outer periphery of the main body that is different from the first distance.

In some aspects, the first tab includes a tab leading edge and a tab trailing edge on opposing ends of the first tab. At least one of the tab leading edge and the tab trailing edge protrude in a direction that is skewed away from the second tab.

In some aspects, the outlet protrudes from an end surface of the main body in a direction parallel to the central axis, the inlet protrudes from the end surface of the main body in a direction parallel to the central axis and offset from the outlet, the outlet and the inlet protruding different distances from the end surface.

In some aspects, one of the inlet and the outlet is coaxial with the central axis, the one of the inlet or the outlet that is coaxial protruding a greater distance from the end surface of the main body than the other of the inlet and the outlet that is not coaxial with the central axis.

In another independent aspect, a filter head is configured to receive a filter cartridge and includes a fluid inlet; a fluid outlet; a flow meter for sensing a flow rate of fluid, the flow meter located in one of the fluid inlet and the fluid outlet; and an electronic processor configured to determine a flow volume based on the sensed flow rate.

In some aspects, the filter head further includes a timer for sensing at least one of an amount of time elapsed during which a filter cartridge has been installed in the filter head and an amount of time during which fluid has flowed through the filter cartridge.

In some aspects, the electronic processor calculates a flow volume based on the sensed flow rate and the amount of time during which fluid has flowed through the filter cartridge.

In some aspects, the filter head further includes a circuit board configured to communicate with a storage medium positioned on the filter cartridge.

In some aspects, the circuit board can transmit information to the storage medium and can receive information from the storage medium.

In some aspects, the circuit board communicates with the storage medium using RFID, NFC, or Bluetooth.

In another independent aspect, a filter includes a filter head and a filter cartridge. The filter head includes an inlet and an outlet; a circuit board; and at least two ledges. The filter cartridge includes a filter cap including an inlet and an outlet extending from a main body of the filter cap; a housing and a filter media each coupled to the filter cap; at least two tabs protruding from the main body; and a microchip for communicating with the circuit board. The at least two ledges are configured to engage the at least two tabs to retain the filter cap in a locked position relative to the filter head.

In some aspects, the tabs of the filter cartridge form an asymmetric profile as viewed along an axis of insertion of the filter cap into the filter head.

In some aspects, the circuit board sends an alert or otherwise inhibits function of a downstream fixture unless it detects the microchip.

In some aspects, the circuit board can transmit information to the microchip and receive information from the microchip.

In some aspects, the filter head includes a flow meter located in either the inlet or the outlet. The circuit board includes a timer. The circuit board can read a flow rate measured by the flow meter and use the flow rate and the timer to measure a total volume of flow passing through the filter.

In some aspects, the inlet of the filter cap includes an integrated check valve.

Other aspects of the disclosure will become apparent by consideration of the detailed description and accompanying drawings.

### BRIEF DESCRIPTION OF THE DRAWINGS

FIG. 1 is a perspective view of a filter head.

FIG. 2 is a top view of the filter head of FIG. 1.

FIG. 3 is side view of a portion of a filter assembly including the filter head of FIG. 1.

FIG. 4 is a perspective view of an outer surface of a filter cap.

FIG. 5A is a perspective view of an inner surface of the filter cap of FIG. 4.

FIG. 5B is a perspective view of an inner surface of a filter cap according to one embodiment.

FIG. 6A is a plan view of an outer surface of the filter cap of FIG. 4.

FIG. 6B is a plan view of an outer surface of the filter cap of FIG. 5B.

FIG. 7 is a bottom view of the filter head of FIG. 1 in a first position.

FIG. 8 is a bottom view of the filter head of FIG. 1 in a second position.

FIG. 9 is another perspective view of a filter head according to one embodiment.

FIG. 10 is a perspective view of the filter assembly of FIG. 3, with a filter cap in a disengaged position.

FIG. 11 is another perspective of the filter assembly of FIG. 3, with the filter cap in an engaged position.

FIG. 12 is a section view of the filter assembly of FIG. 3, viewed along section line 12-12 of the filter head of FIG. 2.

FIG. 13 is a section view of the filter assembly of FIG. 3, viewed along section line 13-13 of the filter head of FIG. 8.

FIG. 14 is a side view of the filter cap of FIG. 4 and a valve plate of the filter head of FIG. 1 in a first position.

FIG. 15 is a perspective view of the filter cap and the valve plate of FIG. 14 in a second position.

FIG. 16 is an exploded perspective view of the filter assembly of FIG. 3.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” “supported,” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (for example, stored on non-transitory computer-readable medium) executable by one or more electronic processors, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” and the like, described in the specification can include one or more electronic processors, one or more computer-readable medium modules, one or more input/output interfaces, and various connections (for example, a system bus) connecting the components.

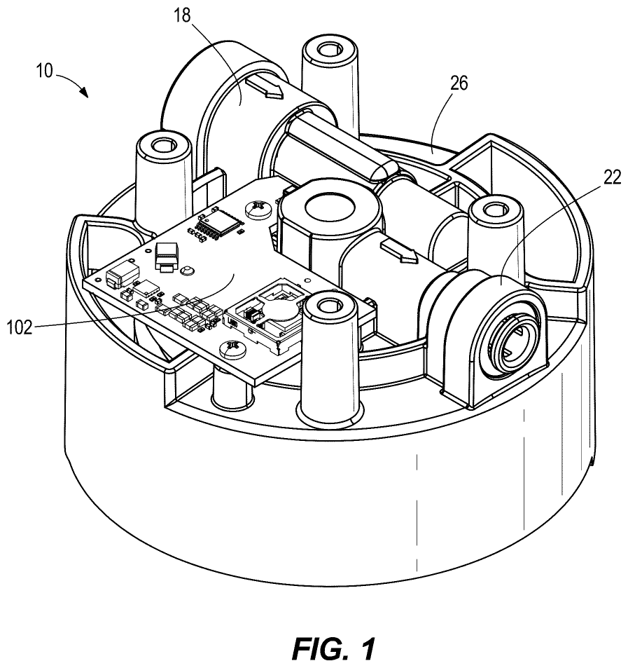

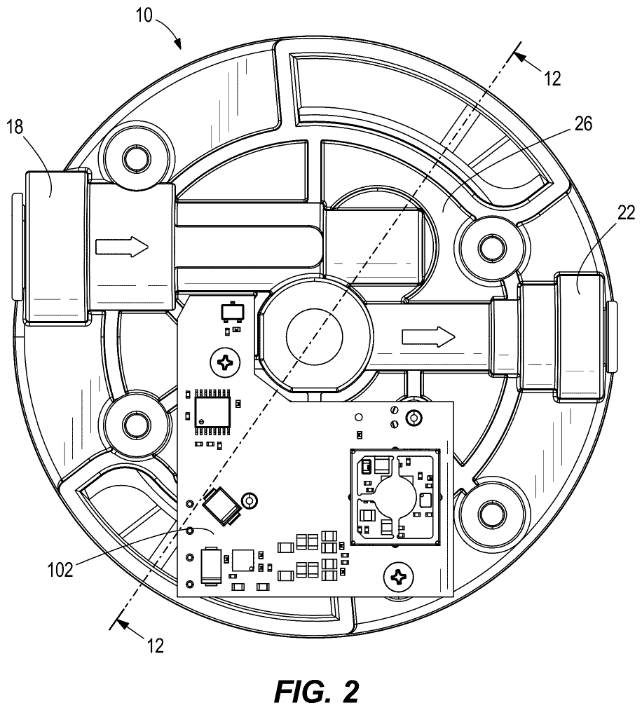

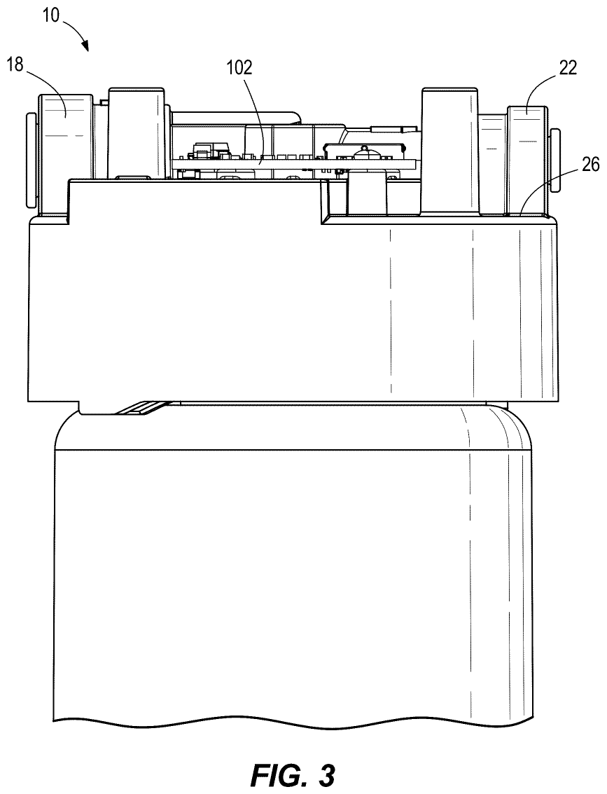

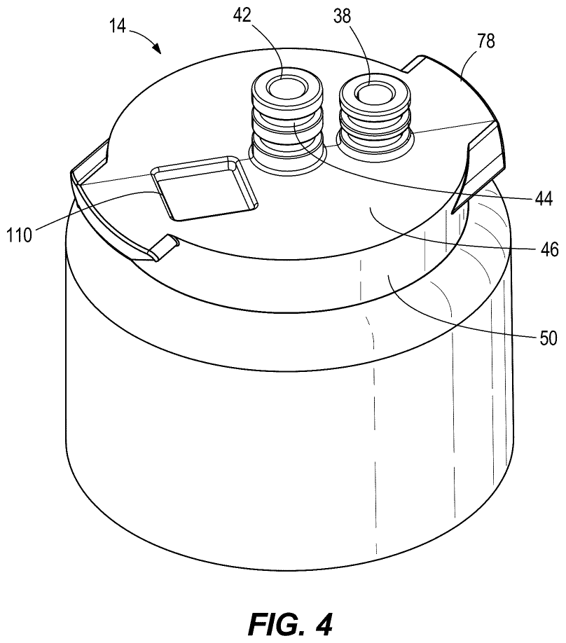

FIGS. 1-3 illustrate a filter head 10 that is configured to be installed in a water supply line to filter water before it is dispensed for drinking or other use at a downstream fixture. In some embodiments, the filter head 10 may be supported in a fixed position of a water dispenser. The filter head 10 may be configured to receive a removable filter cartridge (not shown) to create a filter assembly. The filter cartridge may include a housing and a filter media positioned within the housing. The filter cartridge may include a filter cap 14 (FIGS. 4-6) secured to one end of the housing and configured to engage the filter head 10 to couple the filter cartridge to the filter head 10 such that water passes through and is filtered by the filter cartridge. The filter cap 14 may be configured to lock into position and unlock from the filter head 10 by rotating the filter cap 14 relative to the filter head 10.

As illustrated in FIGS. 1-3, the filter head 10 may include an inlet 18 in fluid communication with a water supply and an outlet 22 in fluid communication with a water dispensing spigot. In the illustrated embodiment, each of the inlet 18 and the outlet 22 of the filter head 10 may extend through an upper surface 26 of the filter head 10 (e.g., as an elbow), forming an inlet opening 30 and an outlet opening 34, respectively. The inlet opening 30 may be coupled to and in fluid communication with the inlet 38 of the filter cap 14, and the outlet opening 34 may be coupled to and in fluid communication with outlet 42 of the filter cap 14.

As shown in FIG. 4, the inlet 38 and outlet 42 of the filter cap 14 may extend or protrude from an outer surface 46 (e.g., an upper surface) of a main body 50 of the filter cap 14. In some embodiments, the inlet 38 and outlet 42 may be different sizes or diameters. For example, as shown in the illustrated embodiment, the diameter of the inlet 38 may be larger than the diameter of the outlet 42. In other embodiments, the inlet 38 and outlet 42 may have the same size. The inlet 38 and outlet 42 may include grooves 44 for receiving O-rings or other seals (not shown) to help provide a water-tight seal with the inlet 18 and outlet 22, respectively, of the filter head 10. In the illustrated embodiment, the outlet 42 may be located proximate the center of the circular main body 50, although it may be offset slightly from the center. The inlet 38 may be radially offset from the outlet 42, and the inlet 38 may be separate and non-overlapping with the outlet 42. In some embodiments, the inlet 38 may be located proximate the center of the main body 50 and the outlet 42 may be radially offset from the inlet 38. The filter media (not shown) may be positioned within a filter housing (not shown) that is coupled to the filter cap 14. Water flowing through the inlet 38 passes through the filter media before exiting to the outlet 42.

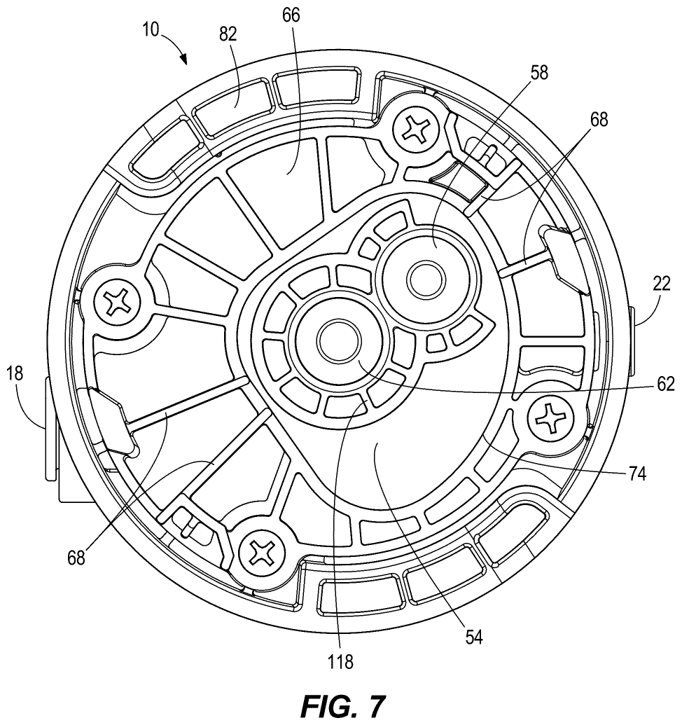

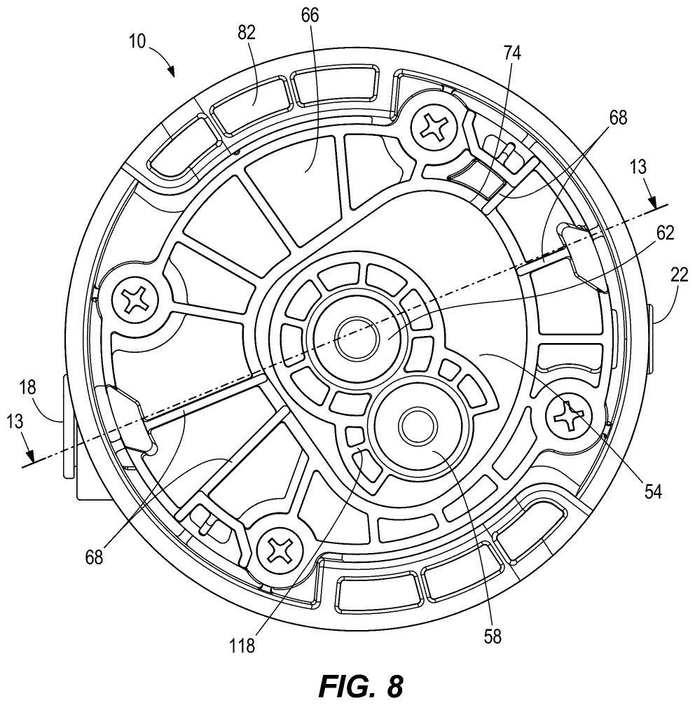

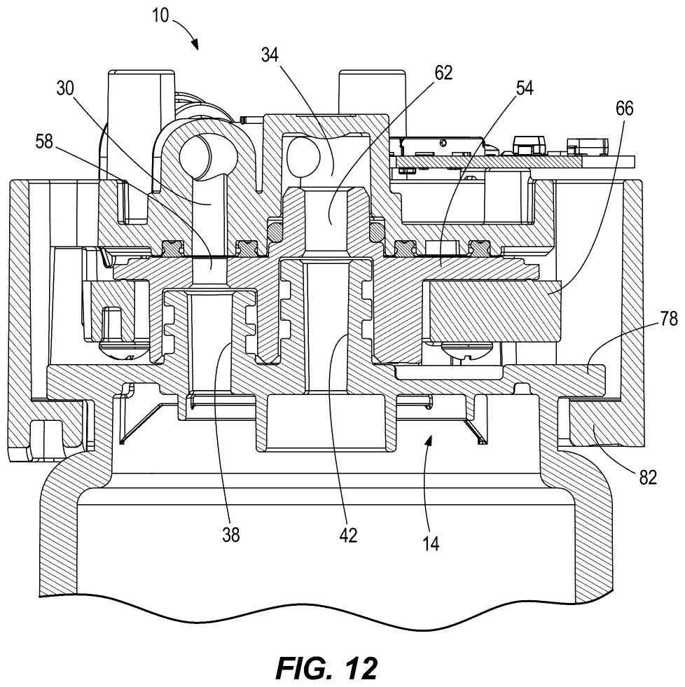

In some embodiments, as illustrated in FIGS. 7 and 8, a valve plate 54 may provide a sealed connection between the inlet 18 of the filter head 10 and the inlet 38 of the filter cap 14, and between the outlet 22 of the filter head 10 and the outlet 42 of the filter cap 14. The valve plate 54 may include a first passage or first opening 58 configured to receive the inlet 38 of the filter cap 14 and a second passage or second opening 62 configured to receive the outlet 42 of the filter cap 14. The valve plate 54 may be retained by a retaining plate 66 that is secured (e.g., by fasteners) to the filter head 10. In some embodiments, the valve plate 54 may be positioned or sandwiched between the retaining plate 66 and filter head 10 so that it is retained within the filter head 10 while still allowing a freedom of rotational movement about an axis that is parallel to a central axis of the filter head 10. In some embodiments, as illustrated in FIG. 12, a portion of the second opening 62 may protrude from the valve plate 54 and be received within the outlet opening 34, which can help align the valve plate 54 with the filter head 10 throughout rotation of the valve plate 54. The first opening 58 may be substantially flush with a top of the valve plate 54 such that the first opening 58 does not obstruct or interfere with the rotation of the valve plate 54 relative to the filter head 10. The protruding inlet 38 and outlet 42 of the filter cap 14 may be inserted into the corresponding first and second openings 58, 62 by translating the filter cap 14 along an insertion direction (i.e., a direction parallel to the central axis of the filter head 10) while the valve plate 54 is in an unlocked position (FIG. 7), and the filter cap 14 and valve plate 54 may then be rotated to a locked position (FIG. 8) in which the filter cap 14 is secured to the filter head 10.

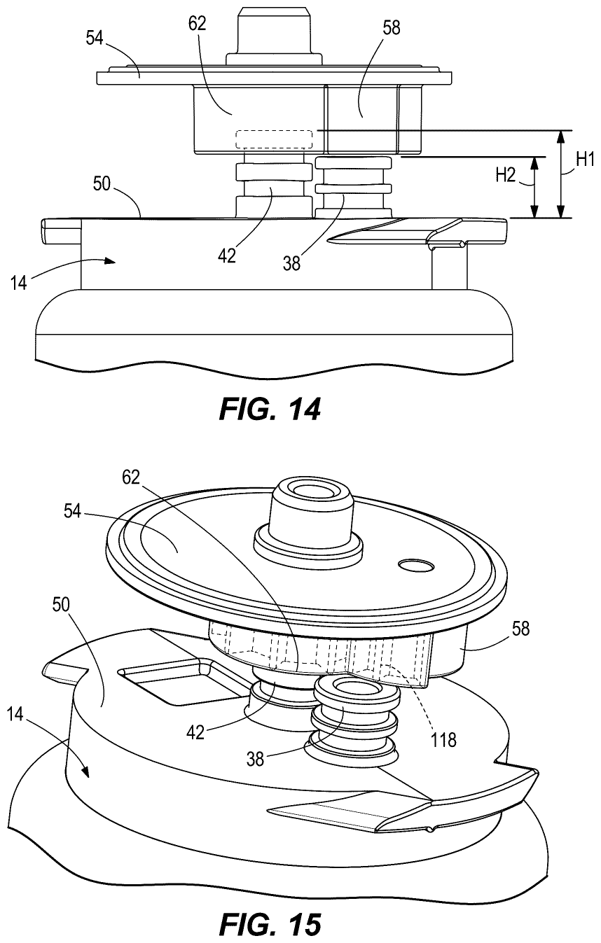

As best shown in FIG. 14, the protruding outlet 42 of the filter cap 14 may extend a distance H1 from the main body 50, and the protruding inlet 38 may extend a distance H2 from the main body 50. Distance HI may be greater than distance H2 such that the protruding outlet 42 may be partially inserted into the second opening 62 of the valve plate 54 while the protruding inlet 38 remains uninserted into the first opening 58 of the valve plate 54. Partially inserting the protruding outlet 42 into the second opening 62 can help provide a pivot point for a user to rotate the filter cap 14 to then align the protruding inlet 38 with the first opening 58. In some embodiments the distance H1 may be approximately 40% greater than the distance H2. In some embodiments, the distance H1 may be approximately 0.16 inches greater than the distance H2. In some embodiments, the distance H1 may be approximately 0.55 inches and the distance H2 may be approximately 0.39 inches.

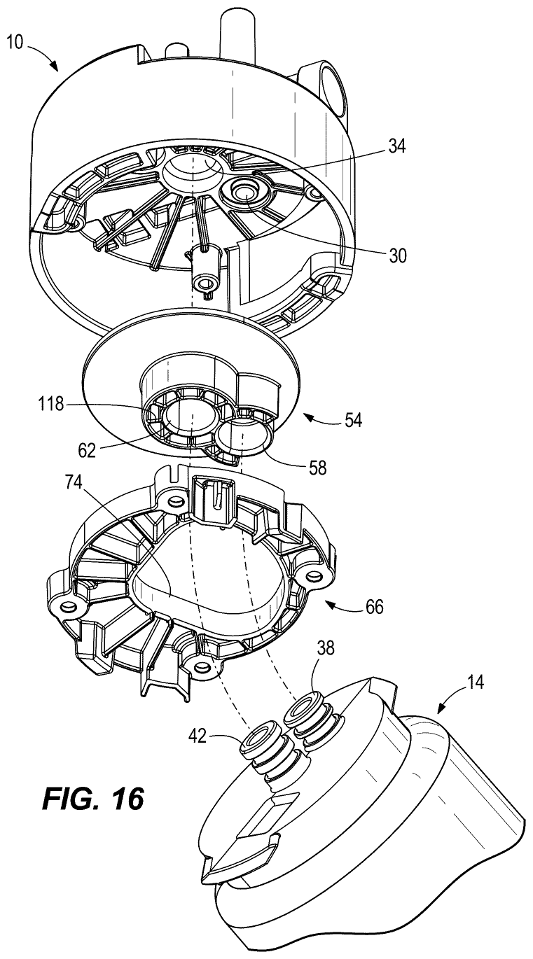

As best shown in FIGS. 15 and 16, the first and second openings 58, 62 may include obstructions or ribs 118 that can interfere with the inlet 38 or outlet 42 to prevent inserting and mating the filter cap 14 to the valve plate 54 without having the inlet 38 or outlet 42 properly aligned with the corresponding first and second openings 58, 62. Thus, the ribs 118 (along with the limited space of the cutout 74 of the retaining plate 66 and engagement of tabs 78 and ledges 82, as described below) can prevent misalignment and improper installation of the filter cap 14 by only allowing the filter cap 14 to be fully inserted when properly aligned with the valve plate 54. As shown in FIGS. 7, 8, and 16, the ribs 118 may radially extend or protrude from an outer surface of the first and second openings 58, 62. In other embodiments, the ribs 118 may be concentrically formed around the first and second openings 58, 62 (e.g., to form a flange).

As shown in FIG. 7, the valve plate 54 may be rotated to an unlocked position before a filter is installed where the first opening 58 is not aligned with the inlet opening 30 of the filter head 10. In some embodiments, when the valve plate 54 is in the unlocked position, the first opening 58 may be aligned with a vent (not shown) of the filter head 10. As shown in FIG. 8, when the valve plate 54 is rotated to the filter installed/locked position (e.g., by rotating approximately a quarter turn from the unlocked position), the first opening 58 may be aligned with the inlet opening 30 of the filter head 10 and water is allowed to flow through the filter cartridge when installed. The retaining plate 66 may include an opening or cutout 74 such that the retaining plate 66 does not interfere with the rotation of the filter cap 14 while it is connected to the valve plate 54.

Filter cartridges, especially the filter media, often have a limited lifespan according to the amount of water that has passed through the filter cartridge (often measured in gallons of flow) and/or according to the amount of time the filter cartridge has been in service. Accordingly, filter cartridges need to be periodically replaced. Aspects of the filter head 10 may prevent the use of unauthorized filter cartridges and help ensure that filter cartridge replacement occurs when needed.

Some filter cartridges (for example, filter cartridges manufactured by third parties) may not be designed/rated for use under the flow conditions of the water dispenser and therefore may not be authorized as replacement filter cartridges. The use of unauthorized filter cartridges can result in poor water filtering and/or damage to the filter head. Thus, it can be desirable to ensure that appropriate filter cartridges are installed in a filter head.

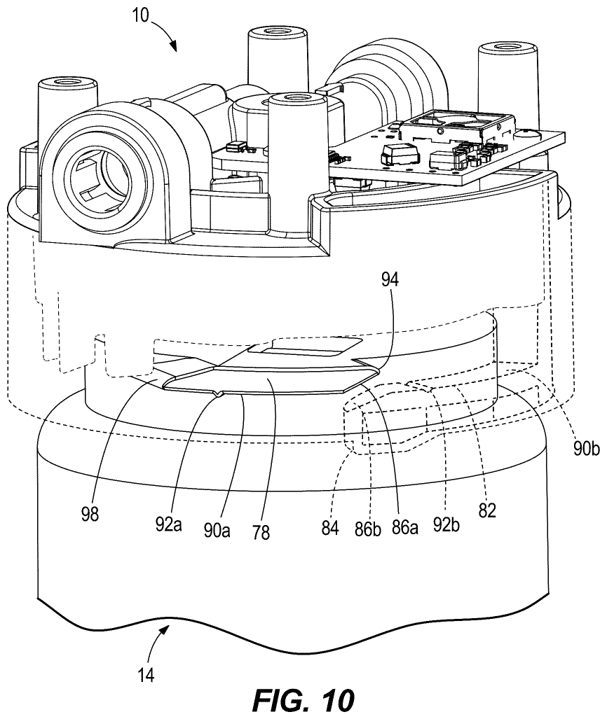

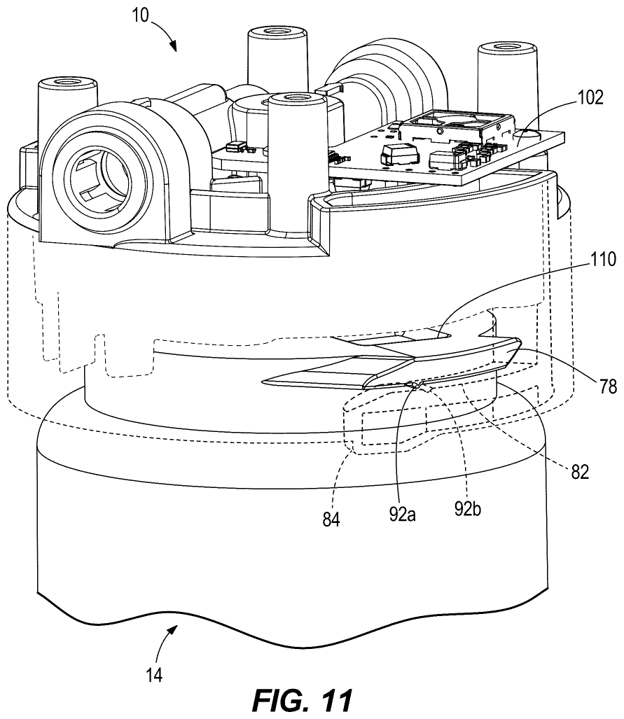

As shown in FIGS. 4-6, the filter cap 14 may include a locking feature that is engageable with a retaining feature of the filter head 10. In the illustrated embodiment, the filter cap 14 includes radially outwardly protruding wings or tabs 78 that engage and are held in place by corresponding retaining features 82 of the filter head 10 (FIGS. 7 and 8). In the illustrated embodiment, the retaining features 82 of the filter head 10 include a radially inwardly protruding ledge 82. As best shown in FIG. 10, each of the tabs 78 of the filter cap 14 may include an end (e.g., a ramp portion 86a) and a flat portion 90a. Similar, each of the inwardly protruding ledges 82 of the filter head 10 may include a ramp portion 86b and a flat portion 90b. As the filter cap 14 is rotated from an unlocked position (FIG. 10) toward a locked/installed position (FIG. 11), the ramp portion 86a of the tabs 78 of the filter cap 14 may move along the ledges 82 of the filter head 10 (e.g., ramp portion 86b), thereby drawing the filter cap 14 toward the valve plate 54 and the filter head 10 to help provide a water-tight seal in the installed position. The flat portions 90a of the tabs 78 and flat portions 90b of ledges 82 may frictionally engage each other to prevent inadvertent release of the filter cap 14 from its locked/installed position.

As shown in FIG. 11, in some embodiments, the flat portion 90a of one of the tabs 78 may include a protrusion 92a, and the flat portion 90b of one of the ledges 82 may include a cavity or recess 92b configured to receive the protrusion 92a to further prevent inadvertent release of the filter cap 14 from its locked/installed position. In other embodiments, the protrusion 92a may be positioned on the ledge 82 of the filter head 10 and the recess 92b may be positioned on one of the tabs 78 of the filter cap 14.

In the illustrated embodiment, the filter head 10 includes two ledges 82 and the filter cap 14 includes two tabs 78. In other embodiments, the filter head 10 and the filter cap 14 may include fewer or more ledges and tabs. In the illustrated embodiments, the ledges 82 are positioned on opposite sides of the filter head 10 and the tabs 78 are positioned on opposite sides of the filter cap 14. In other embodiments, the ledges and/or tabs may be positioned in a different manner.

As shown in FIGS. 10 and 11, blocks or stops 84 may protrude downwardly from ledges 82 to prevent a user from inserting a filter cap 14 in skewed or crooked manner (e.g., with one tab 78 of the filter cap 14 engaging the correct side of the ledge 82, but with the other tab 78 of the filter cap 14 positioned adjacent a lower side of the ledge 82 such that the tab does not properly engage the ledge 82). The stop 84 may abut a skewed or misaligned tab 78 and prevent rotation of the filter cap 14 until the filter cap 14 is properly leveled and aligned such that both tabs 78 will engage the upper flat portion 90 of the ledges 82 once rotated. In some embodiments, stops 84 may be included on other portions of the filter head 10 (e.g., outer lower walls of the filter head 10 proximate the ledges 82) such that stops 84 prevent misalignment or skewed rotation of the filter cap 14 into the filter head 10.

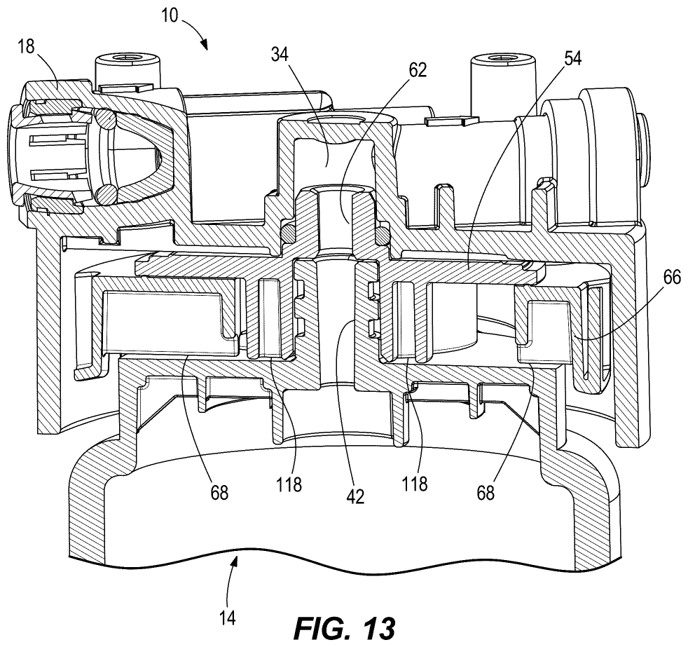

As shown in FIG. 13, the retaining plate 66 may include ribs 68 that extend downward a distance such that bottom of the ribs 68 are positioned to abut a top surface of the filter cap 14 when the filter cap 14 is in the installed position. The ribs 68 can prevent tilting of the filter cap 14 in the installed position. Preventing tilt of the filter cap 14 may be especially critical when the filter head 10 is mounted such that the filter cartridge of the filter cap 14 extends in a horizontal direction and the weight of the cartridge biases an end of the filter cartridge downward and the filter cap 14 to tilt or angle relative to the filter head 10. The ribs 68 may also provide additional backing to prevent the filter cap 14 and/or tabs 78 from being skewed as the filter cap 14 is rotated for the tabs 78 to engage the ledges 82 of the filter head 10. As shown in FIGS. 7 and 8, the extended ribs 68 may be positioned between the ledges 82 of the filter head 10. The ribs 68 may reduce the amount of “play” in the tab 78 position as the tab 78 is inserted above the associated ledge 82, thereby reducing possible tilt or skew of the filter cap 14 because the tab 78 is biased to remain aligned and slide above the ledge 82 while maintaining an adjacent upper surface of the filter cap 14 (and/or trailing edge 98 of the tab 78) below the bottom of the extended ribs 68. In some embodiments, extended ribs 68 may be arranged around the entire circumference of the filter head 10.

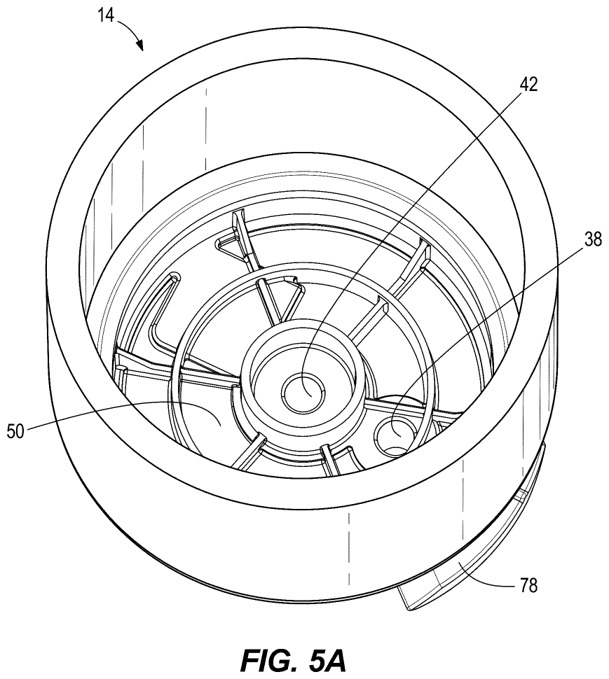

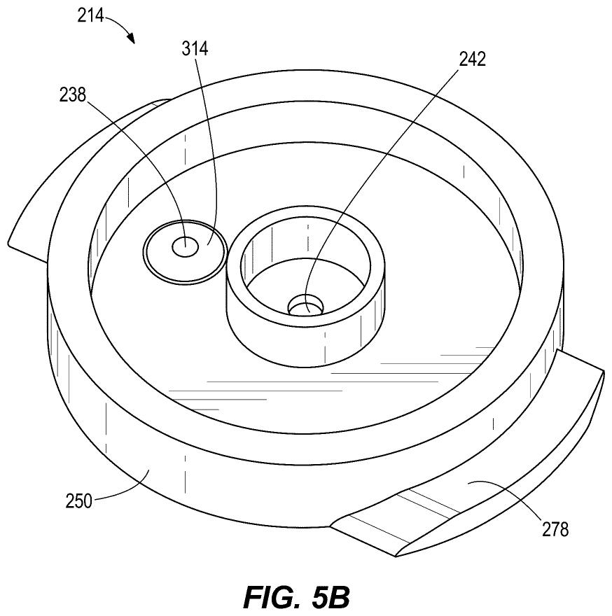

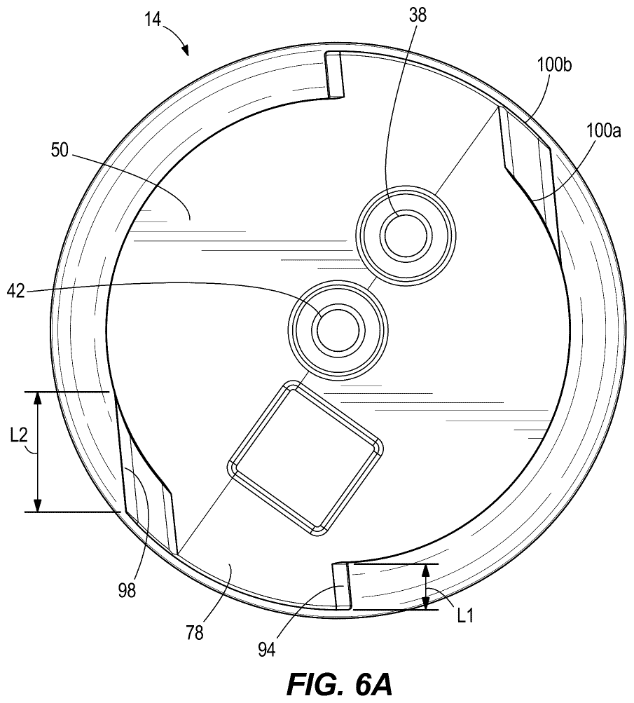

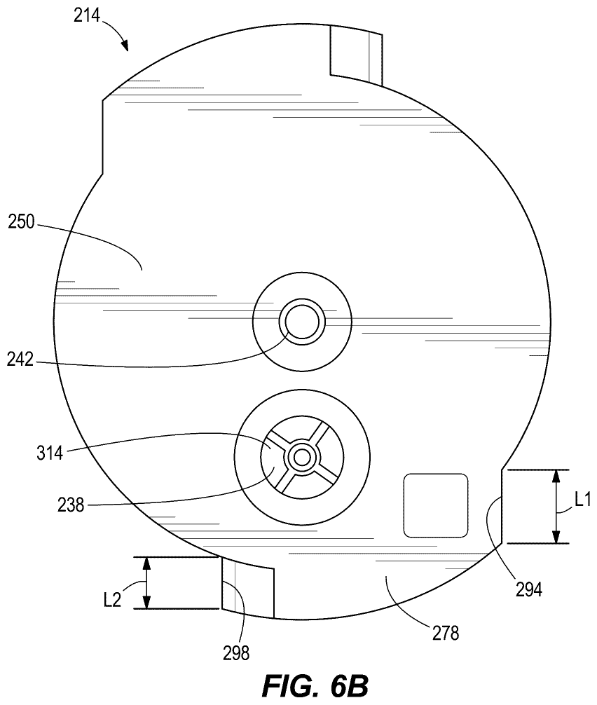

FIGS. 5B and 6B illustrate a filter cap 214 according to another embodiment. Features of the filter cap 214 that are similar to features of the filter cap 14 are identified with similar reference numbers, plus two hundred. Aspects of the filter caps 14, 214 are described herein, primarily with reference to filter cap 14.

Referring to FIG. 6A, each protrusion or tab 78 of the filter cap 14 may include a leading edge 94 and a trailing edge 98. As the filter and filter cap 14 is rotated in the filter head 10 from the unlocked position to the locked position, the leading edge 94 initially contacts the complementary ledge 82 of the filter head 10 and slides above the complementary ledge 82. The overall profile of the filter cap 14 may have an asymmetric shape.

As shown in FIG. 6A, the tabs 78 of the filter cap 14 may protrude from a body 50 of the filter cap 14 in an eccentric manner. Stated another way, the tabs 78 may be positioned on diametrically opposite edges of the body 50, and angularly offset from one another. Stated yet another way, the tabs 78 of the filter cap 14 may be non-concentric with a center axis of the filter cap 14. In some embodiments, the leading edge 94 of each tab 78 may protrude by a distance L1 from an outer edge of the body 50 of the filter cap 14, the trailing edge 98 may protrude by a distance L2 from the outer edge of the body 50, and the distance L1 may be different than the distance L2. In some embodiments the distance L1 may be smaller than the distance L2 (FIG. 6A), and in other embodiments the distance L1 may be greater than the distance L2 (FIG. 6B). As illustrated, the leading edge 94 and trailing edge 98 may each protrude or extend from an outer edge of the body 50 at an oblique angle relative to the outer edge of the body 50 and may each protrude at different angles relative to the outer edge of the body 50. In some embodiments, the leading edge 94 and/or the trailing edge 98 may protrude substantially tangentially to the outer edge of the body 50 (for example, see the trailing edge 98 in FIG. 6A). In other embodiments, the leading edge 94 or trailing edge 98 may protrude or extend perpendicularly relative to the outer edge of the body 50. As illustrated, the leading edge 94 and trailing edge 98 of a tab 78 may protrude in a direction skewed away from the opposing tab 78 (i.e., a line extending along and beyond the leading edge 94 in FIG. 6A would not intersect any portion of the opposite tab 78). The leading edge 94 or trailing edge 98 of a tab 78 may be “flared”. Put another way, a radially inner edge may have a longer circumferential length than the radially outer edge for a given leading edge 94 or trailing edge 98 (e.g., as illustrated in FIG. 6A, the radially inner edge 100a has a longer circumferential length than the radially outer edge 100b of the trailing edge 98). In some embodiments, a radius of curvature of the tabs 78 is different and/or non-concentric with a radius of curvature of the body 50. The asymmetric profile of the filter cap 14 complicates duplication of the filter cap 14 and therefore inhibits use of non-authorized filter cartridges with the filter head 10.

In some embodiments, the center outlet 42 may be offset (e.g., non-concentric) with a center axis of the filter cap 14. As shown in FIG. 12, the second opening 62 of the valve plate 54 may be centrally located relative to the outlet opening 34, and the outlet 42 of the filter cap 14 may be slightly offset from the second opening 62, while still permitting water flow through the outlet 22.

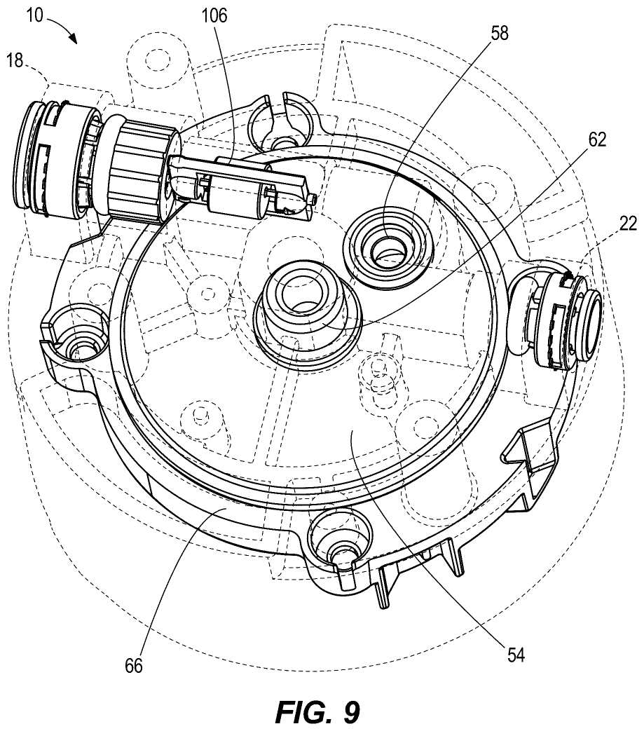

The filter head 10 may include a circuit board 102 that enables the filter assembly to utilize smart features to enhance the filter efficiency and lifespan. For example, as illustrated in FIG. 9, the inlet 18 of the filter head 10 may include a flow sensor or flow meter 106. In other embodiments the flow meter 106 may be included in the outlet 22 or another portion of the filter head 10. In some embodiments, the flow meter 106 may be a turbine type flow meter. The flow meter 106 may be connected to the circuit board 102 to provide precise measurement of the flow rate of water into the filter. The circuit board 102 may further include a timer and a processor to track the total volume of water flow passing through a filter by measuring the time and flow rate together. The circuit board 102 can send or provide an alert, and/or can automatically shut down the dispensing fixture once the total rated flow volume of the filter cartridge has been reached. Rather than providing a rough estimate of the water volume based on an estimated flow rate (which may result in the filter being replaced more frequently than necessary), the flow meter 106 provides more accurate measurement of the water volume.

In some instances, a user may manually reset the timer and/or total volume of flow measurements on the circuit board 102 when installing a new filter. In some embodiments, the filter cap 14 may include a microchip (not shown) that can communicate with the circuit board 102 to automatically alert the circuit board 102 when a new filter has been installed. The filter cap 14 may include a microchip recess 110 (FIG. 4) in its outer surface 46 to hold the microchip. The microchip may communicate with the circuit board 102, for example, using an RFID tag. In other embodiments, another type of wireless communication (e.g., Bluetooth, NFC, etc.) may be used. As best illustrated in FIG. 11, the microchip recess 110 may be located in the filter cap 14 such that the microchip is located proximate the circuit board 102 when the filter cap 14 is rotated to its locked/installed orientation.

The microchip can both receive and transmit data or information with the circuit board 102 (e.g., has both read and write capabilities). For example, the microchip may communicate to the circuit board 102 an indicator of a maximum service limit (e.g., maximum hours and/or maximum volume of flow). The circuit board 102 in turn can communicate to the microchip (and the microchip may store) the usage of the filter (e.g., the total hours and/or the total volume of flow). This will enable the microchip in the filter to keep track of its updated lifespan even if it is removed from a given filter head 10 and reinstalled at a later date or installed in a different filter head 10. Thus, the microchip being able to receive data from the circuit board 102 can help prevent installation of old or worn filters. The circuit board 102 can also be configured to send a signal to prevent the fixture from operating or otherwise inhibit the function of the downstream fixture unless a certified microchip is detected by the circuit board 102. This can help ensure that only filters that meet the specifications for a given filter head 10 or application are installed and used.

In some embodiments, each filter includes a unique RFID tag or a storage medium to assist with tracking and relaying information regarding the real-time filter status, filter activation time, post-filter flush, flow measurement (count of bottles filled or volume of water that has flowed through the filter), and filter authentication as described below. With respect to filter activation time, an endpoint device may be connected directly to a solenoid valve. When power is sent, the endpoint measures a time that the power is flowing to the solenoid. The endpoint may also log the event as dispensing water and relay the information to another device.

The system may also measure flow of fluid through the filter (for example, a count of bottles filled or volume of water that has flowed through the filter). In some embodiments, the flow meter 106 may include magnetic tips that rotate at a speed proportional to a fluid flow rate. A hall effect sensor is mounted on a printed circuit board assembly (PCBA) mounted on the top of the filter head assembly. As the turbine rotates, the hall effect sensor counts turbine revolutions by monitoring the magnetic pulses that the rotation generates. The PCBA may also be equipped with a microcontroller unit (MCU) which translates this pulse data into data packets and sends them via serial communication to the main control board. The control board uses this flow rate data to calculate total volume of water dispensed and updates this value in its memory. In some embodiments, a display screen may be updated with a bottle count, and filter usage (volume) is transmitted to a PCBA to update filter usage data on the filter RFID tag.

The flow measurement also provides the ability to differentiate between the bottle filter usage (bottle count) and drinking fountain usage (volume from drinking fountain). The differentiation may indicate different flow rates from the bottle filler versus the drinking fountain. Additionally, the end point device may detect a solid low signal for the bottle filler status and a 120 Hz pulse for the drinking fountain. Alternatively, the flow volume can be calculated using the measured solenoid activation time and a known flow rate.

The filter head 10 may monitor real-time status of the filter cartridge. In some embodiments, a filter status may be determined based on a calculation of the volume of fluid that has flowed through the filter as well as an activation time of the filter (e.g., the total time since installation of the filter cartridge, plus any additional time as stored on the RFID tag on the filter cartridge). The filter status may be transmitted to the RFID tag on the filter. In addition, the PCBA may set a status of a display (e.g., an LED) in different colors depending on status. For example, the display may be GREEN when the filter is installed, YELLOW when either a predetermined percentage (e.g., 50%) of the maximum activation time has been reached or a predetermined percentage (e.g., 50%) of a maximum flow volume has been reached, or RED when either a maximum activation time has been reached or a maximum flow volume has been reached.

The PCBA may detect whether a filter cartridge is an authorized filter. For example, each authorized filter may be equipped with an RFID tag programmed by a supplier with a unique serial number or “tag ID,” a maximum volume capacity (e.g., in gallons), a maximum activation time (e.g., in hours), a current filter usage (e.g., a time initially set at 0 hours and a volume initially set at 0 gallons), and filter type. In some embodiment, an RFID/NFC transceiver is located on the PCBA mounted to the filter head 10. Upon installation of the filter, the on-board transceiver may register the filter tag ID and pass it to a main bottle filler control board (not shown) where the data may be hashed or encrypted. If the encrypted tag ID matches an expected hashing result, the control board saves the tag ID to memory and communicates approval back to the NFC board. If filter usage is below 80% for both time and volume, the green LED will illuminate. If the hashed tag ID does not match the expected result, filter authentication fails and the red LED illuminates.

When the control board detects a new filter tag ID, it will initiate a filter flush via the bottle filler solenoid. The flow meter 106 monitors flow through the filter cartridge, allowing the control system to cease flow once 1 gallon has been dispensed. While this is happening, a message may be displayed to indicate the pre-activation flush is being performed. The duration of the filter flush may be significantly longer than a typical user operation. In some embodiments, a typical operation may be limited to 20 second intervals, and the pre-activation flush may dispense one gallon and last at least one minute. The flush operation ensures full filter saturation and rinses away debris with minimal user input, thereby saving time and effort on unit maintenance. The bottle filler or dispensing device may initiate a line flush if the dispensing device has not been activated for a set period of time to ensure a minimum volume of water periodically flows through the filter and dispensing device and to help prevent accumulation of particulates in the line and other devices.

As best shown in FIG. 5B, the filter cap 214 may include an integrated check valve 314 positioned in the inlet 238. The check valve 314 can help prevent water in the filter cartridge from flowing or leaking back through the inlet 238. Preventing such backflow can help extend the life of the filter media by reducing the amount of reverse flow through the filter media. Preventing backflow can also prevent other issues, including potential interference with the flow meter 106. In the illustrated embodiment, the check valve 314 is an umbrella-style valve. The umbrella-style valve may be made of an elastomeric material that allows the check valve 314 to deform due to pressure and water flow from the upstream side, which allows water to flow through, but the check valve 314 will not deform or allow water through due to pressure from the downstream side. In other embodiments, the check valve 314 may be incorporated in the filter head 10.

The embodiment(s) described above and illustrated in the figures are presented by way of example only and are not intended as a limitation upon the concepts and principles of the present disclosure. It will be understood that certain features and sub combinations are of utility and may be employed without reference to other features and sub combinations. Features described and illustrated with respect to certain embodiments may also be implemented in other embodiments. This is contemplated by and is within the scope of the claims. Since many possible embodiments of the disclosure may be made without departing from the scope thereof, it is also to be understood that all matters herein set forth or shown in the accompanying drawings are to be interpreted as illustrative and not limiting. As such, it will be appreciated that variations and modifications to the elements and their configuration and/or arrangement exist within the spirit and scope of one or more independent aspects as described.

What is claimed is:

1. A filter interface for coupling a filter cartridge to a filter head for a water dispensing fixture, the interface comprising:
a first inlet positioned on the filter head;
a second inlet positioned on a filter cap of the filter cartridge, the second inlet selectively coupled to the first inlet to provide fluid communication between the first inlet and the second inlet while the filter cap is secured relative to the filter head;
at least two ledges positioned on one of the filter head and the filter cap; and
at least two tabs positioned on the other of the filter head and the filter cap, each of the tabs protruding in a radial direction, the filter cap and filter head being coupled by translating the filter cap along an insertion direction and rotating the filter cap about the insertion direction toward a locked position, thereby causing each of the tabs to engage one of the ledges and secure the filter cap relative to the filter head, the tabs positioned asymmetrically as viewed along the insertion direction.

2. The filter interface of claim 1, wherein the tabs are positioned on the filter cap and the ledges are positioned on the filter head.

3. The filter interface of claim 2, wherein each of the tabs includes a tab leading edge for sliding along one of the ledges as the filter cap is rotated about the insertion direction and a tab trailing edge on an opposite end of each of the tabs, wherein one of the tab leading edge and the tab trailing edge protrudes substantially tangentially from an outer periphery of the filter cap.

4. The filter interface of claim 2, wherein each of the tabs includes a tab leading edge for sliding along one of the ledges as the filter cap is rotated about the insertion direction and a tab trailing edge on an opposite end of each of the tabs, the tab leading edge protruding a first distance from an outer periphery of the filter cap, the tab trailing edge protruding a second distance from the outer periphery of the filter cap that is different from the first distance.

5. The filter interface of claim 2, wherein the at least two tabs are a first tab and second opposing tab, wherein the first tab includes a tab leading edge for sliding along one of the ledges as the filter cap is rotated about the insertion direction and a tab trailing edge on an opposite end of the first tab, wherein at least one of the tab leading edge and the tab trailing edge protrude in a direction that is skewed away from the second opposing tab.

6. The filter interface of claim 2, wherein each of the ledges includes a leading edge having a stop protruding parallel to the insertion direction, the stop abutting one of the tabs of the filter cartridge to prevent a misaligned rotation of the filter cartridge relative to the filter head.

7. The filter interface of claim 1, further comprising a first outlet positioned on the filter head, and a second outlet positioned on the filter cap, the second outlet selectively coupled to the first outlet to provide fluid communication between the first outlet and the second outlet while the filter cap is secured relative to the filter head.

8. The filter interface of claim 7, wherein the second outlet protrudes from an end surface of the filter cap in a direction parallel to the insertion direction, and the second inlet protrudes from the end surface of the filter cap in a direction parallel to the insertion direction and offset from the second outlet, the second outlet protruding from the end surface by a first distance, the second inlet protruding from the end surface a second distance that is less than the first distance.

9. The filter interface of claim 8, wherein the first distance is approximately 40% greater than the second distance.

10. The filter interface of claim 7, further comprising a valve plate supported for rotation relative to the filter head, the valve plate including a first passage and a second passage, the first passage of the valve plate configured to receive the second inlet and the second passage of the valve plate is configured to receive the second outlet,
wherein, while the filter cap is secured relative to the filter head, the first passage of the valve plate provides fluid communication between the first inlet and the second inlet, and the second passage of the valve plate provides fluid communication between the first outlet and the second outlet.

11. The filter interface of claim 10, further comprising a rib protruding from an outer surface of the first passage, the rib configured to interfere with the filter cap and prevent coupling the filter head and the filter cap when the filter cap is misaligned with the first passage.

12. The filter interface of claim 10, further comprising a retaining plate secured to the filter head,
wherein the valve plate is positioned between the retaining plate and a main body of the filter head,
wherein the retaining plate includes a cutout, the second inlet and the second outlet extending through the cutout while the second inlet is positioned in the first passage and the second outlet is positioned in the second passage of the valve plate,
wherein the retaining plate includes a rib protruding parallel to the insertion direction, the rib engaging an end surface of the filter cap while the filter cap is secured relative to the filter head.

13. A filter cap for fluidly coupling a filter cartridge to a filter head for a water dispensing feature, the filter cap comprising:
a main body having a round profile defining a central axis;
an inlet configured to provide a first fluid passageway between the filter cartridge and the filter head;
an outlet configured to provide a second fluid passageway between the filter cartridge and the filter head, the second fluid passageway being distinct from the first fluid passageway;
a first tab protruding radially from an outer periphery of the main body; and
a second tab protruding radially from the outer periphery of the main body, the second tab protruding asymmetrically relative to the first tab;
wherein the first tab and second tab are each configured to selectively engage one of a first and second ledge of the filter head as the filter cap is rotated about the central axis to selectively secure the filter cap to the filter head.

14. The filter cap of claim 13, wherein the first tab includes a tab leading edge and a tab trailing edge on opposing ends of the first tab, wherein one of the tab leading edge and the tab trailing edge protrudes substantially tangentially from an outer periphery of the main body.

15. The filter cap of claim 13, wherein the first tab includes a tab leading edge and a tab trailing edge on opposing ends of the first tab, the tab leading edge protruding a first distance from an outer periphery of the main body, the tab trailing edge protruding a second distance from the outer periphery of the main body that is different from the first distance.

16. The filter cap of claim 13, wherein the first tab includes a tab leading edge and a tab trailing edge on opposing ends of the first tab, wherein at least one of the tab leading edge and the tab trailing edge protrude in a direction that is skewed away from the second tab.

17. The filter cap of claim 13, wherein the outlet protrudes from an end surface of the main body in a direction parallel to the central axis, the inlet protrudes from the end surface of the main body in a direction parallel to the central axis and offset from the outlet, the outlet and the inlet protruding different distances from the end surface.

18. The filter cap of claim 17, wherein one of the inlet and the outlet is coaxial with the central axis, the one of the inlet or the outlet that is coaxial protruding a greater distance from the end surface of the main body than the other of the inlet and the outlet that is not coaxial with the central axis.

19. A filter head configured to receive a filter cartridge, the filter head comprising:
a fluid inlet;
a fluid outlet;
a flow meter for sensing a flow rate of fluid, the flow meter located in one of the fluid inlet and the fluid outlet; and
an electronic processor configured to determine a flow volume based on the sensed flow rate.

20. The filter head of claim 19, further comprising a timer for sensing at least one of an amount of time elapsed during which a filter cartridge has been installed in the filter head and an amount of time during which fluid has flowed through the filter cartridge.

21. The filter head of claim 20, wherein the electronic processor calculates a flow volume based on the sensed flow rate and the amount of time during which fluid has flowed through the filter cartridge.

22. The filter head of claim 19, further comprising a circuit board configured to communicate with a storage medium positioned on the filter cartridge.

23. The filter head of claim 22, wherein the circuit board can transmit information to the storage medium and can receive information from the storage medium.

24. The filter head of claim 22, wherein the circuit board communicates with the storage medium using RFID, NFC, or Bluetooth.

25. A filter assembly comprising:
a filter head including:
an inlet and an outlet;
a circuit board; and
at least two ledges; and
a filter cartridge including:
a filter cap including an inlet and an outlet extending from a main body of the filter cap;
a housing and a filter media each coupled to the filter cap;
at least two tabs protruding from the main body; and
a microchip for communicating with the circuit board;
wherein the at least two ledges are configured to engage the at least two tabs to retain the filter cap in a locked position relative to the filter head.

26. The filter assembly of claim 25, wherein the tabs of the filter cartridge form an asymmetric profile as viewed along an axis of insertion of the filter cap into the filter head.

27. The filter assembly of claim 25, wherein the circuit board sends an alert or otherwise inhibits function of a downstream fixture unless it detects the microchip.

28. The filter assembly of claim 25, wherein the circuit board can transmit information to the microchip and receive information from the microchip.

29. The filter assembly of claim 25, wherein the filter head includes a flow meter located in either the inlet or the outlet, wherein the circuit board includes a timer, and wherein the circuit board can read a flow rate measured by the flow meter and use the flow rate and the timer to measure a total volume of flow passing through the filter.

30. The filter assembly of claim 25, wherein the inlet of the filter cap includes an integrated check valve.
